(19) United States
(12) Patent Application Publication
(10) Pub. No.: US 2025/0323387 A1
(43) Pub. Date: Oct. 16, 2025

(54) BATTERY

(71) Applicant: TOYOTA JIDOSHA KABUSHIKI KAISHA, Toyota-shi (JP)

(72) Inventors: Takayuki SUGIYAMA, Toyota-shi (JP); Hajime Kurikuma, Inuyama-shi (JP); Motokuni Maruhashi, Toyota-shi (JP); Hiromasa Tanaka, Okazaki-shi (JP); Akio Uotani, Toyota-shi (JP); Kazuya Kumazawa, Nagoya-shi (JP)

(73) Assignee: TOYOTA JIDOSHA KABUSHIKI KAISHA, Toyota-shi (JP)

(21) Appl. No.: 19/066,348

(22) Filed: Feb. 28, 2025

(30) Foreign Application Priority Data
Apr. 12, 2024 (JP) 2024-064616

(51) Int. Cl. H01M 50/517; H01M 50/209; H01M 50/507

(52) U.S. Cl. CPC H01M 50/517; H01M 50/209; H01M 50/507

(57) ABSTRACT

A battery includes a first cell stack (FCS) and a second cell stack (SCS) in which rectangular cells (RCs), each having a terminal provided on respective end surfaces thereof in longitudinal direction, are stacked. FCS and SCS are arranged side by side so that first and second ends of FCS correspond to first and second ends of SCS, respectively, in stacking direction. A base part of a first end bus bar (FEBB) is fixed to a terminal of RC positioned the closest to the first end of FCS, and a base part of a second end bus bar (SEBB) is fixed to a terminal of RC positioned the closest to the first end of SCS. SEBB's tip end part (TEP) is arranged below FEBB's TEP and shifted toward the first end of SCS, and FEBB's TEP and SEBB's TEP are arranged side by side in stacking direction.

### CROSS REFERENCE TO RELATED APPLICATIONS

This application is based upon and claims the benefit of priority from Japanese patent application No. 2024-064616, filed on Apr. 12, 2024, the disclosure of which is incorporated herein in its entirety by reference.

### BACKGROUND

The present disclosure relates to a battery.

In a conventional battery, a terminal is provided on respective upper surfaces of the stacked rectangular cells. Recently, a battery in which a terminal is provided on respective end surfaces of the stacked rectangular cells as disclosed in Patent Literature 1 has been developed.

Patent Literature 1: United States Patent Application Publication No., 2022/0302533

### SUMMARY

The inventors have developed a battery including a plurality of cell stacks that are arranged side by side. In the aforementioned battery in which a terminal is provided on respective end surfaces of the rectangular battery cells in a longitudinal direction, end bus bars for external connection are fixed to the terminals of the rectangular cells that are positioned at end parts in the stacking direction. Therefore, there is a problem that the end bus bars interfere with each other and spacing between the cell stacks that are arranged side by side becomes large.

The present disclosure is made in view of the aforementioned circumstances and provides a battery capable of suppressing an increase in spacing between a plurality of cell stacks that are arranged side by side.

According to an aspect of the present disclosure, a battery includes:
first and second cell stacks each having a rectangular parallelepiped shape and in which a plurality of rectangular cells, each having a terminal provided on respective end surfaces thereof in a longitudinal direction, are stacked, in which
the first and second cell stacks are arranged side by side so that first and second ends of the first cell stack correspond to first and second ends of the second cell stack, respectively, in a stacking direction of the plurality of the rectangular cells,
a base part of a first end bus bar is fixed to a terminal of a rectangular cell of the first cell stack, which is positioned the closest to the first end of the first cell stack,
a base part of a second end bus bar is fixed to a terminal of a rectangular cell of the second cell stack, which is positioned the closest to the first end of the second cell stack,
a tip end part of the second end bus bar is arranged below a tip end part of the first end bus bar and at a position shifted toward the first end of the second cell stack, and
the tip end part of the first end bus bar and the tip end part of the second end bus bar are arranged side by side in the stacking direction of the plurality of the rectangular cells.

In the battery according to the present disclosure, a base part of a first end bus bar is fixed to a terminal of a rectangular cell of the first cell stack, which is positioned the closest to the first end of the first cell stack, a base part of a second end bus bar is fixed to a terminal of a rectangular cell of the second cell stack, which is positioned the closest to the first end of the second cell stack, a tip end part of the second end bus bar is arranged below a tip end part of the first end bus bar and at a position shifted toward the first end of the second cell stack, and the tip end part of the first end bus bar and the tip end part of the second end bus bar are arranged side by side in the stacking direction of the plurality of the rectangular cells.

Therefore, the first and second end bus bars that are arranged so as to oppose each other, do not interfere with each other, and an increase in spacing between the first and second cell stacks that are arranged side by side can be suppressed.

The tip end part of the first end bus bar may be mounted on a first support stand that is fixed to the first end of the first cell stack, and the tip end part of the second end bus bar may be mounted on a second support stand that is fixed to the first end of the second cell stack. With this configuration, the positions of the tip end parts of the first and second end bus bars can be stabilized.

A screw rod provided on the first support stand may be inserted into a through hole provided in the tip end part of the first end bus bar, and a screw rod provided on the second support stand may be inserted into a through hole provided in the tip end part of the second end bus bar. With such a configuration, the positions of the tip end parts of the first and second end bus bars can be further stabilized.

The first support stand may be fixed to an end plate at the first end of the first cell stack, and the second support stand may be fixed to an end plate at the first end of the second cell stack.

The first support stand may be bolted to the end plate at the first end of the first cell stack, the second support stand may be bolted to the end plate at the first end of the second cell stack, and the end plate at the first end of the first cell stack and the end plate at the first end of the second cell stack may be arranged at positions shifted in the stacking direction. With such a configuration, the bolts connecting the first and second support stands do not interfere with each other, and an increase in spacing between the first and second cell stacks that are arranged side by side can be suppressed.

According to the present disclosure, it is possible to provide a battery capable of suppressing an increase in spacing between a plurality of cell stacks arranged side by side.

The above and other objects, features and advantages of the present disclosure will become more fully understood from the detailed description given hereinbelow and the accompanying drawings.

### BRIEF DESCRIPTION OF DRAWINGS

FIG. 1 is a schematic perspective view of a battery according to a first embodiment;

FIG. 2 is a schematic perspective view of a battery according to the first embodiment;

FIG. 3 is a schematic side view of a cell stack CS1 arranged on the side opposing a cell stack CS2;

FIG. 4 is a schematic side view of the cell stack CS2 arranged on the side opposing the cell stack CS1;

FIG. 5 is a schematic side view showing an arrangement relationship between an end bus bar EB11 of the cell stack CS1 and an end bus bar EB21 of the cell stack CS2 on a first end side;

FIG. 6 is a schematic plan view showing an arrangement relationship between the end bus bar EB11 of the cell stack CS1 and the end bus bar EB21 of the cell stack CS2 on a first end side; and

FIG. 7 is a schematic side view showing an arrangement relationship between an end bus bar EB12 of the cell stack CS1 and an end bus bar EB22 of the cell stack CS2 on a second end side.

### DESCRIPTION OF EMBODIMENTS

Hereinafter, specific embodiments of the present disclosure will be described in detail with reference to the drawings. However, the present disclosure is not limited to the following embodiments. In order to clarify the description, the following description and drawings are simplified as appropriate.

### First Embodiment

### Structure of Battery

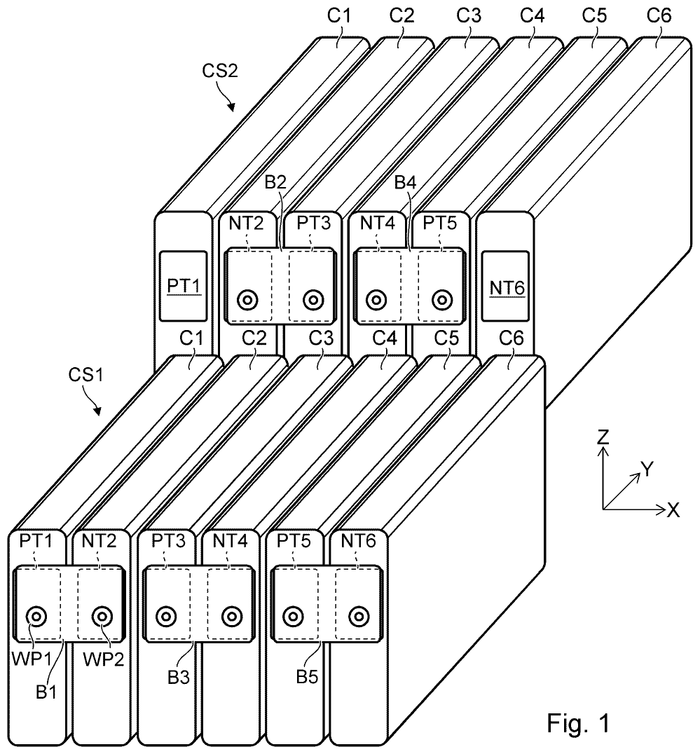

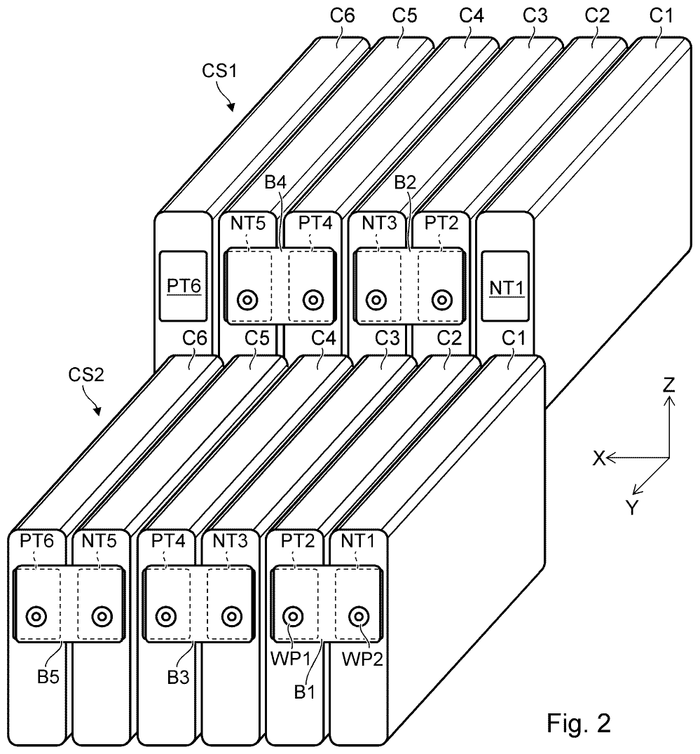

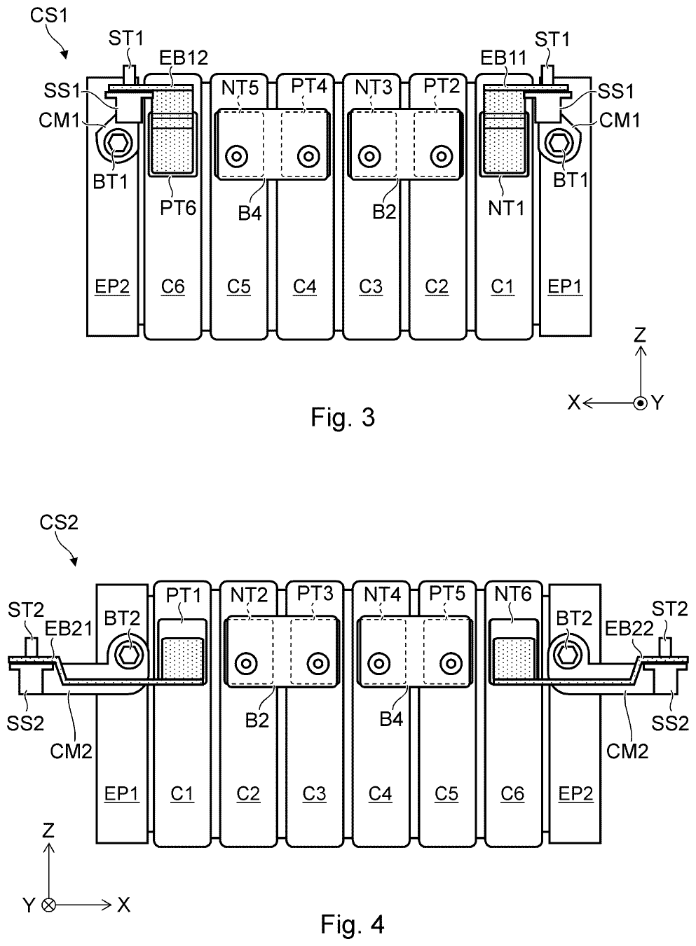

First, the structure of a battery according to a first embodiment will be described with reference to FIGS. 1 to 4. FIG. 1 is a schematic perspective view showing the battery according to the first embodiment. FIG. 2 is a schematic perspective view showing the battery according to the first embodiment. FIG. 3 is a schematic side view of a cell stack CS1 arranged on the side opposing a cell stack CS2. FIG. 4 is a schematic side view of the cell stack CS2 arranged on the side opposing the cell stack CS1.

The battery according to the present embodiment is applied, for example, to vehicle-mounted use. The is no limitation on the vehicles on which the battery according to the present embodiment is mounted, and examples thereof include an electric vehicle, a hybrid vehicle, a fuel cell electric vehicle (FCEV), and the like that can be driven by electric power supplied from the battery. It should be noted that the right-handed XYZ orthogonal coordinate system shown in FIGS. 1 to 4 and other drawings is for the sake convenience in explaining the position relationship of the components. In FIG. 1 and other drawings, normally, the Z-axis positive side is the vertically upward direction and the XY plane is a horizontal plane, which are common throughout the drawings.

As shown in FIGS. 1 and 2, the battery according to the first embodiment includes the cell stacks CS1 and CS2. As shown in FIGS. 1 and 2, the cell stacks CS1 and CS2 extend in the X-axis direction. As shown in FIGS. 1 and 2, the cell stacks CS1 and CS2 are arranged side by side in the Y-axis direction such that a first end (X-axis negative-side end part) and a second end (X-axis negative-side end part) of the cell stack CS1 correspond to those of the cell stack CS2, respectively, in the stacking direction (X-axis direction) inside a case.

It should be noted that in FIGS. 1 and 2, spacing between the cell stacks CS1 and CS2 is illustrated to be wider than it is for the sake of clarity in showing the respective configurations of the cell stacks CS1 and CS2. In FIGS. 1 and 2, the cell stacks CS1 and CS2 are illustrated to be arranged at positions shifted in the X-axis direction from their actual positions.

As shown in FIGS. 1 and 2, the cell stacks CS1 and CS2 have substantially the same configuration and each of the cell stacks CS1 and CS2 is provided with a plurality of rectangular cells C1 to C6 and bus bars B1 to B5. As shown in FIG. 3, the cell stack CS1 is provided with end plates EP1 and EP2 and the end bus bars EB11 and EB12, which are not shown in FIGS. 1 and 2. Further, as shown in FIG. 4, the cell stack CS2 is provided with the end plates EP1 and EP2 and the end bus bars EB21 and EB22, which are not shown in FIGS. 1 and 2.

As shown in FIGS. 1 and 2, the rectangular cells C1 to C6 are rectangular cells having a rectangular parallelepiped shape extending in the Y-axis direction. The rectangular cells C1 to C6 are stacked in the thickness direction (X-axis direction) thereby configuring the cell stacks CS1 and CS2. The rectangular cells C1 to C6 are, for example, secondary batteries such as lithium-ion batteries, nickel-metal hydride batteries, or the like.

The cell stacks CS1 and CS2 shown in FIGS. 1 and 2 are illustrated in a simplified form. The cell stacks CS1 and CS2 shown in FIGS. 1 and 2 are configured of the six rectangular cells C1 to C6, but are usually configured of more than six rectangular cells. On the other hand, the number of the rectangular cells configuring the cell stacks CS1 and CS2 is not particularly limited and may be any plural number.

A heat insulating plate or a spacer for adjusting spacing between adjacent rectangular cells may be inserted between the adjacent rectangular cells.

As shown in FIG. 1, in the cell stacks CS1 and CS2, a positive electrode terminal PT1 is provided on one end surface (Y-axis negative-side end surface) of the rectangular cell C1 in the longitudinal direction. Although not particularly limited, the positive electrode terminal PT1 shown in FIG. 2 has a rectangular shape in the XZ plan view and is arranged so as to protrude outward from an end surface of the rectangular cell C1. The positive electrode terminal PT1 shown in FIG. 1 is provided on the upper side (on the Z-axis positive-side) of the end surface of the rectangular cell C1. The positive electrode terminal PT1 is made of, for example, a metal material such as copper excellent in conductivity.

Similarly, as shown in FIG. 1, a negative electrode terminal NT2 is provided on one end surface (Y-axis negative-side end surface) in the longitudinal direction of the rectangular cell C2 adjacent to the rectangular cell C1. A positive electrode terminal PT3 is provided on one end surface (Y-axis negative-side end surface) in the longitudinal direction of the rectangular cell C3 adjacent to the rectangular cell C2. A negative electrode terminal NT4 is provided on one end surface (Y-axis negative-side end surface) in the longitudinal direction of the rectangular cell C4 adjacent to the rectangular cell C3. A positive electrode terminal PT5 is provided on one end surface (Y-axis negative-side end surface) in the longitudinal direction of the rectangular cell C5 adjacent to the rectangular cell C4. A negative electrode terminal NT6 is provided on one end surface (Y-axis negative-side end surface) in the longitudinal direction of the rectangular cell C6 adjacent to the rectangular cell C5.

As shown in FIG. 1, the negative electrode terminal NT2 of the rectangular cell C2, the positive electrode terminal PT3 of the rectangular cell C3, the negative electrode terminal NT4 of the rectangular cell C4, the positive electrode terminal PT5 of the rectangular cell C5, and the negative electrode terminal NT6 of the rectangular cell C6 have the same shape and arrangement as those of the positive electrode terminal PT1 of the rectangular cell C1.

On the other hand, as shown in FIG. 2, in the cell stacks CS1 and CS2, a negative electrode terminal NT1 is provided on the other end surface (Y-axis positive-side end surface) of the rectangular cell C1 in the longitudinal direction. Although not particularly limited, the negative electrode terminal NT1 shown in FIG. 2 has a rectangular shape in the XZ plan view, as is the positive electrode terminal PT1 shown in FIG. 1, and is arranged so as to protrude outward from an end surface of the rectangular cell C1. The negative electrode terminal NT1 shown in FIG. 2 is provided on the upper side (Z-axis positive-side) of the end surface of the rectangular cell C1, as is the positive electrode terminal PT1 shown in FIG. 1. Like the positive electrode terminal PT1, the negative electrode terminal NT1 is made of, for example, a metal material excellent in conductivity, such as copper.

Similarly, as shown in FIG. 2, a positive electrode terminal PT2 is provided on the other end surface (Y-axis positive-side end surface) in the longitudinal direction of the rectangular cell C2 adjacent to the rectangular cell C1. A negative electrode terminal NT3 is provided on the other end surface (Y-axis positive-side end surface) in the longitudinal direction of the rectangular cell C3 adjacent to the rectangular cell C2. A positive electrode terminal PT4 is provided on the other end surface (Y-axis positive-side end surface) in the longitudinal direction of the rectangular cell C4 adjacent to the rectangular cell C3. A negative electrode terminal NT5 is provided on the other end surface (Y-axis positive-side end surface) in the longitudinal direction of the rectangular cell C5 adjacent to the rectangular cell C4. A positive electrode terminal PT6 is provided on the other end surface (Y-axis positive-side end surface) of the rectangular cell C6 adjacent to the rectangular cell C5 in the longitudinal direction.

As shown in FIG. 2, the positive electrode terminal PT2 of the rectangular cell C2, the negative electrode terminal NT3 of the rectangular cell C3, the positive electrode terminal PT4 of the rectangular cell C4, the negative electrode terminal NT5 of the rectangular cell C5, and the positive electrode terminal PT6 of the rectangular cell C6 have the same shape and arrangement as those of the negative electrode terminal NT1 of the rectangular cell C1.

Here, as shown in FIG. 1, on one end surface (Y-axis negative-side end surface) of the cell stack CS1, the positive electrode terminal PT1 of the adjacent rectangular cell C1 and the negative electrode terminal NT2 of the rectangular cell C2, which are adjacently arranged, are electrically connected through the plate-like bus bar B1. Similarly, the positive electrode terminal PT3 of the rectangular cell C3 and the negative electrode terminal NT4 of the rectangular cell C4, which are adjacently arranged, are electrically connected through the plate-like bus bar B3. Similarly, the positive electrode terminal PT5 of the rectangular cell C5 and the negative electrode terminal NT6 of the rectangular cell C6, which are adjacently arranged, are electrically connected through the plate-like bus bar B5.

As shown in FIGS. 2 and 3, on the other end surface (Y-axis positive-side end surface) of the cell stack CS1, the positive electrode terminal PT2 of the rectangular cell C2 and the negative electrode terminal NT3 of the rectangular cell C3, which are adjacently arranged, are electrically connected through the plate-like bus bar B2. Similarly, the positive electrode terminal PT4 of the rectangular cell C4 and the negative electrode terminal NT5 of the rectangular cell C5, which are adjacently arranged, are electrically connected through the plate-like bus bar B4. Thus, in the cell stack CS1 shown in FIGS. 1 and 2, the rectangular cells C1 to C6 are connected in series by the bus bars B1 to B5.

As shown in FIG. 3, the base part of the end bus bar EB11 is fixed to the negative electrode terminal NT1 of the rectangular cell C1 of the cell stack CS1. As shown in FIG. 3, the base part of the end bus bar EB12 is fixed to the positive electrode terminal PT6 of the rectangular cell C6 of the cell stack CS1. Details of the end bus bars EB11 and EB12 of the cell stack CS1 will be described later.

On the other hand, as shown in FIGS. 1 and 4, on one end surface (Y-axis negative-side end surface) of the cell stack CS2, unlike the cell stack CS1, the negative electrode terminal NT2 of the rectangular cell C2 and the positive electrode terminal PT3 of the rectangular cell C3, which are adjacently arranged, are electrically connected through the plate-like bus bar B2. Similarly, the negative electrode terminal NT4 of the rectangular cell C4 and the positive electrode terminal PT5 of the rectangular cell C5, which are adjacently arranged, are electrically connected through the plate-like bus bar B4.

As shown in FIG. 2, also on the other end surface (Y-axis positive-side end surface) of the cell stack CS2, unlike the cell stack CS1, the negative electrode terminal NT1 of the rectangular cell C1 and the positive electrode terminal PT2 of the rectangular cell C2, which are adjacently arranged, are electrically connected through the plate-like bus bar B1. Similarly, the negative electrode terminal NT3 of the rectangular cell C3 and the positive electrode terminal PT4 of the rectangular cell C4, which are adjacently arranged, are electrically connected through the plate-shaped bus bar B3. Similarly, the negative electrode terminal NT5 of the rectangular cell C5 and the positive electrode terminal PT6 of the rectangular cell C6, which are adjacently arranged, are electrically connected through the plate-shaped bus bar B5.

Thus, in the cell stack CS2 shown in FIGS. 1 and 2, the rectangular cells C1 to C6 are connected in series by the bus bars B1 to B5.

Incidentally, as shown in FIG. 4, the base part of the end bus bar EB21 is fixed to the positive electrode terminal PT1 of the rectangular cell C1 of the cell stack CS2. Further, as shown in FIG. 4, the base part of the end bus bar EB22 is fixed to the negative electrode terminal NT6 of the rectangular cell C6 of the cell stack CS2.

Details of the end bus bars EB21 and EB22 of the cell stack CS2 will be described later.

The bus bars B1 to B5 shown in FIGS. 1 and 2 are bus bars connecting the rectangular cells C1 to C6. Since the bus bars B1 to B5 have the same configuration, the bus bar B1 will be described.

As shown in FIGS. 1 and 2, the bus bar B1 is a plate-like member that electrically connects a terminal (the positive electrode terminal PT1 or the negative electrode terminal NT1) of the rectangular cell C1 and a terminal (the negative electrode terminal NT2 or the positive electrode terminal PT2) of the rectangular cell C2, which are adjacently arranged. The bus bar B1 is made of, for example, a metal material excellent in conductivity, such as copper.

As shown in FIGS. 1 and 2, the bus bar B1 is, for example, plate-like member of rectangular shape in the XZ plan view. The bus bar B1 is provided so as to cover substantially the entire terminal of the rectangular cell C1 (the positive electrode terminal PT1 or the negative electrode terminal NT1) and the terminal of the rectangular cell C2 (the negative electrode terminal NT2 or the positive electrode terminal PT2). The bus bar B1 is provided with a pair of welded parts WP1 and WP2 that are welded to the terminal of the rectangular cell C1 and the terminal of the rectangular cell C2, respectively, which are adjacently arranged.

Although not particularly limited, the welded parts WP1 and WP2 shown in FIGS. 1 and 2 are provided at both ends in the X-axis direction on the lower side (Z-axis negative-side) of the bus bar B1. Here, FIGS. 1 and 2 show the welded parts WP1 and WP2 before welding. The welded parts WP1 and WP2 shown in FIGS. 1 and 2 are countersunk and are thinner than the other regions. The welded parts WP1 and WP2 shown in FIGS. 1 and 2 have circular shape in the XZ plan view and a through hole in the center part thereof.

The welding method is not particularly limited, but for example, in the bus bar B1 of the cell stack CS1 shown in FIG. 1, the bus bar B1 is welded to the positive electrode terminal PT1 of the rectangular cell C1 in the welded part WP1 by irradiating the welded part WP1 with a laser beam from the Y-axis negative-side. Similarly, in the welded part WP2, the bus bar B1 is welded to the negative electrode terminal NT2 of the rectangular cell C2 by irradiating the welded part WP2 with a laser beam from the Y-axis negative-side.

As shown in FIGS. 3 and 4, the end plate EP1 is arranged at X-axis negative-side end part of the stacked rectangular cells C1 to C6. The end plate EP2 is arranged at X-axis positive-side end part of the stacked rectangular cells C1 to C6. That is, the end plates EP1 and EP2 press the stacked rectangular cells C1 to C6 from both ends in the stacking direction (X-axis direction) to thereby bind the stacked rectangular cells.

The end plates EP1 and EP2 are made of a metal material such as aluminum.

As shown in FIG. 3, on the Y-axis positive-side end surface of the end plates EP1 and EP2 of the cell stack CS1, a support stand SS1 supporting the respective tip end parts of the end bus bars EB11 and EB12 is fixed by a bolt BT1 via a connecting member CM1. More specifically, the root of the connecting member CM1 is fixed to the end plates EP1 and EP2, respectively, by the bolt BT1, and the support stand SS1 is fixed to the tip end of the connecting member CM1.

On the other hand, as shown in FIG. 4, on the Y-axis negative-side end surface of the end plates EP1 and EP2 of the cell stack CS2, a support stand SS2 supporting the respective tip end parts of the end bus bars EB21 and EB22 is fixed by a bolt BT2 via a connecting member CM2. More specifically, the root of the connecting member CM2 is fixed to the end plates EP1 and EP2, respectively, by the bolt BT1, and the support stand SS1 is fixed to the tip end of the connecting member CM2.

Here, as shown in FIG. 4, the support stand SS2 is arranged so as to project outward from the cell stack CS2, that is, toward the X-axis negative-side of the end plate EP1 or toward the X-axis positive-side of the end plate EP2. Therefore, the connecting member CM2 for connecting the support stand SS2 to the end plates EP1 and EP2 is extended so as to project outward from the end plates EP1 and EP2 in the X-axis direction.

Here, the end bus bars EB11 and EB12 of the cell stack CS1 shown in FIG. 3 and the end bus bars EB21 and EB22 of the cell stack CS2 shown in FIG. 4 have different shapes.

The battery according to the present embodiment may have a plurality of cell stacks, but the number of the cell stacks is not limited to two. For example, the battery according to the present embodiment may have a plurality of pairs of the cell stacks CS1 and CS2.

### Detailed Configuration of End Bus Bars

Next, referring to FIGS. 3 and 4, a detailed configuration of the end bus bars (first end bus bars) EB11 and EB12 of the cell stack CS1 and the end bus bars (second end bus bars) EB21 and EB22 of the cell stack CS2 will be described.

Although FIGS. 3 and 4 are side views, the end bus bars EB11 and EB12 of the cell stack CS1 and the end bus bars EB21 and EB22 of the cell stack CS2 are shown as dots for ease of understanding.

While the bus bar B1 to B5 shown in FIGS. 1 and 2 are bus bars for connecting the rectangular cells C1 to C6, the end bus bars EB11 and EB12 shown in FIG. 3 are bus bars for connecting the cell stack CS1 to external components. Similarly, the end bus bars EB21 and EB22 shown in FIG. 4 are bus bars for connecting the cell stack CS2 to external components.

The end bus bars EB11, EB12, EB21 and EB22 are plate-like members made of a metal material such as copper excellent in conductivity, for example, similar to the bus bars B1 to B5.

First, the end bus bars EB11 and EB12 of the cell stack CS1 will be described with reference to FIG. 3. As described above, FIG. 3 shows a side view of the cell stack CS1 arranged on the side opposing the cell stack CS2. That is, the end bus bars EB11 and EB12 are provided on a side surface of the cell stack CS1 arranged on the side opposing the cell stack CS2.

As shown in FIG. 3, base part of the end bus bar EB11 is fixed to a terminal of the rectangular cell C1, that is, the negative electrode terminal NT1, which is positioned the closest to the first end side (X-axis negative-side) of the cell stack (first cell stack) CS1. The fixing method is not particularly limited, but welding, for example, may be used.

The end bus bar EB11 projects upward (Z-axis positive-side) of the negative electrode terminal NT1, and is bent in the Y-axis positive-side so that its main surface is parallel to the XY plane at a side below the upper surface of the rectangular cell C1. The tip end part of the end bus bar EB11 extended to the end plate EP1 side (X-axis negative-side) is mounted on the support stand (first support stand) SS1 fixed to the end plate EP1.

Note that the first end side of the cell stack CS1 may be the X-axis positive-side and the second end side may be the X-axis negative-side.

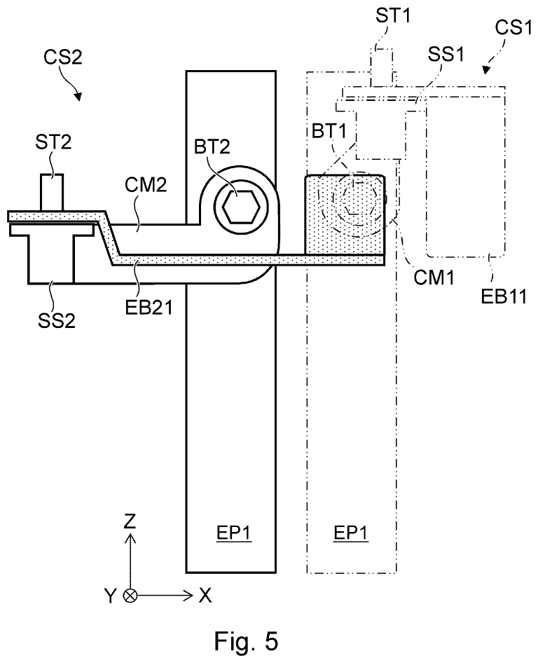

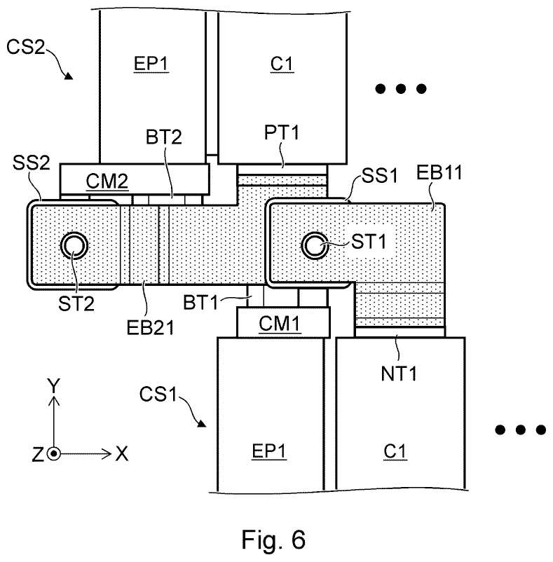

FIG. 5 is a schematic side view showing the arrangement relationship between the end bus bar EB11 of the cell stack CS1 and the end bus bar EB21 of the cell stack CS2 at the first end side. FIG. 6 is a schematic plan view showing the arrangement relationship between the end bus bar EB11 of the cell stack CS1 and the end bus bar EB21 of the cell stack CS2 at the first end side.

In FIG. 5, the end bus bar EB11 and the like configuring the cell stack CS1 are shown by chain double-dotted dashed lines.

As shown in FIG. 6, the support surface of the support stand SS1 has, for example, a rectangular shape in the XY plan view. As shown in FIGS. 3 and 6, a stud (a screw rod) ST1 extending in the Z-axis direction is provided at the center part of the support surface of the support stand SS1. The stud ST1 provided in the support stand SS1 is inserted into a through hole provided in the tip end part of the end bus bar EB11 mounted on the support stand SS1.

As shown in FIG. 3, the end bus bar EB12 has a shape that is mirror-symmetrical with the end bus bar EB11 in the YZ plane. Specifically, as shown in FIG. 3, the base part of the end bus bar EB12 is fixed to a terminal of the rectangular cell C6, that is, the positive electrode terminal PT6, which is positioned the closest to the second end side (X-axis positive-side) of the cell stack CS1.

The end bus bar EB12 protrudes upward (Z-axis positive-side) from the positive electrode terminal PT6, and is bent in the Y-axis positive-side so that its main surface is parallel to the XY plane on the lower side of the upper surface of the rectangular cell C6. The tip end part of the end bus bar EB12 extended to the end plate EP2 side (X-axis positive-side) is mounted on the support stand SS1 fixed to the end plate EP2.

Here, the support stand SS1 that is fixed on the end plate EP2 has the same shape as that of the support stand SS1 that is fixed on the end plate EP1, and is arranged in mirror symmetry with the support stand SS1 that is fixed to the end plate EP1 with respect to the YZ plane. Like the end bus bar EB11, the stud ST1 that is fixed on the support stand SS1 is inserted into a through hole that is provided in the tip end part of the end bus bar EB12 that is mounted on the support stand SS1.

Next, the end bus bars EB21 and EB22 of the cell stack CS2 will be described with reference to FIG. 4. As described above, FIG. 4 shows a side view of the cell stack CS2 arranged on the side opposing the cell stack CS1. That is, the end bus bars EB21 and EB22 are provided on a side surface of the cell stack CS2 arranged on the side opposing the cell stack CS1.

As shown in FIG. 4, the base part of the end bus bar EB21 is fixed to a terminal of the rectangular cell C1, that is, the positive electrode terminal PT1, which is positioned the closest to the first end side (X-axis negative-side) of the cell stack (second cell stack) CS2. On the lower side (Z-axis negative-side) of the positive electrode terminal PT1, the end bus bar EB21 is bent in the Y-axis negative-side so that its main surface is parallel to the XY plane. The tip end part of the end bus bar EB21 extended to the end plate EP1 side (X-axis negative-side) is mounted on the support stand (second support stand) SS2 fixed to the end plate EP1.

Here, as shown in FIG. 4, the support stand SS2 is provided to project outward from the cell stack CS2, that is, to X-axis negative-side of the end plate EP1. Therefore, the connecting member CM2 for connecting the support stand SS2 to the end plate EP1 is extended from the end plate EP1 to the X-axis negative-side. On the other hand, the support stand SS1 shown in FIG. 3 is provided inside the cell stack CS1, that is, to the end plate EP1.

As shown in FIG. 6, the support surface of the support stand SS2 has, for example, a rectangular shape in the XY plane view. As shown in FIGS. 4 and 6, a stud ST2 extending in the Z-axis direction is provided at the center part of the support surface of the support stand SS2. The stud ST2 provided in the support stand SS2 is inserted into the through hole provided in the tip end part of the end bus bar EB21 mounted on the support stand SS2.

As shown in FIG. 4, the end bus bar EB22 has a shape that is mirror symmetrical to the end bus bar EB21 with respect to the YZ plane. Specifically, as shown in FIG. 4, the base part of the end bus bar EB22 is fixed to a terminal of the rectangular cell C6, that is, the negative electrode terminal NT6, which is positioned the closest to the second end side (X-axis positive-side) of the cell stack CS2. On the lower side of the negative electrode terminal NT6, the end bus bar EB22 is bent in the Y-axis negative-side so that its main surface is parallel to the XY plane. The tip end part of the end bus bar EB21 extended to the end plate EP2 side (X-axis negative-side) is mounted on the support stand SS2 fixed to the end plate EP2.

Here, the support stand SS2 fixed to the end plate EP2 has the same shape as that of the support stand SS2 that is fixed to the end plate EP1, and is arranged in mirror symmetry with the support stand SS2 that is fixed to the end plate EP1 with respect to the YZ plane.

Specifically, as shown in FIG. 4, the support stand SS2 fixed to the end plate EP2 is arranged so as to project outward from the cell stack CS2, i.e., further outward in the X-axis positive-side than the end plate EP2. Therefore, the connecting member CM2 for connecting the support stand SS2 to the end plate EP2 extends toward the X-axis positive-side from the end plate EP2. Similarly to the end bus bar EB21, the stud ST2 provided on the support stand SS2 is inserted into the through hole provided on the tip end part of the end bus bar EB22 mounted on the support stand SS2.

### Arrangement Relationship Between End Bus Bar EB11 and End Bus Bar EB21 on First End Side

Now, the arrangement relationship between the end bus bar EB11 of the cell stack CS1 and the end bus bar EB21 of the cell stack CS2 on the first end side (the X-axis negative-side) will be described with reference to FIGS. 5 and 6.

As shown in FIG. 5, the tip end part of the end bus bar EB21 is arranged below the tip end part of the end bus bar EB11 and at a position shifted toward the first end side (the X-axis negative-side). As shown in FIG. 6, the tip end part of the end bus bar EB11 and the tip end part of the end bus bar EB21 are arranged side by side in the stacking direction of the rectangular cells C1 to C6. Therefore, the end bus bars EB11 and EB21 that are arranged so as to oppose each other do not interfere with each other, and an increase in spacing between the cell stacks CS1 and CS2 that are arranged side by side can be suppressed.

Here, as shown in FIGS. 5 and 6, the tip end part of the end bus bar EB11 is mounted on the support stand SS1 that is fixed to the end plate EP1 of the cell stack CS1. The tip end part of the end bus bar EB21 is mounted on the support stand SS2 that is fixed to the end plate EP1 of the cell stack CS2. The support stands SS1 and SS2 are adapted to stabilize the positions of tip end parts of the end bus bars EB11 and EB21. Note that the support stands SS1 and SS2 are not essential.

As described above, the stud ST1 provided in the support stand SS1 is inserted into the through hole provided in the tip end part of the end bus bar EB11. In addition, the stud ST2 provided in the support stand SS2 is inserted into the through hole provided in the tip end part of the end bus bar EB21. With this configuration, the end bus bars EB11 and EB21 can be further stabilized in position.

Further, as shown in FIGS. 5 and 6, the end plate EP1 of the cell stack CS1 and the end plate EP1 of the cell stack CS2 are arranged at positions shifted in the stacking direction (X-axis direction). In the illustrated example, the end plate EP1 of the cell stack CS1 is arranged at positions shifted in the X-axis positive-side, being closer thereto than the end plate EP1 of the cell stack CS2.

With this configuration, since the bolt BT1 which fixes the support stand SS1 to the end plate EP1 and the bolt BT2 which fixes the support stand SS2 to the end plate EP1 do not interfere with each other, an increase in spacing between the cell stacks CS1 and CS2 which are arranged side by side can be suppressed. The end plates EP1 of the cell stacks CS1 and CS2 may be arranged at positions that are not shifted in the stacking direction.

### Arrangement Relationship Between End Bus Bars EB12 and EB22 on the Second End Side

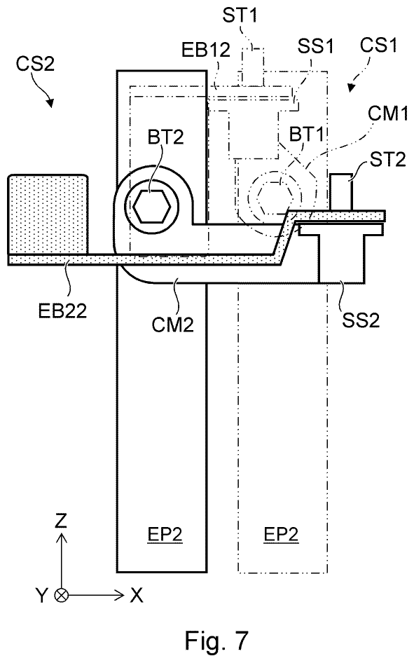

Next, the arrangement relationship between the end bus bar EB11 of the cell stack CS1 and the end bus bar EB21 of the cell stack CS2 on the second end side (X-axis positive-side) will be described with reference to FIG. 7. FIG. 7 is a schematic side view showing the arrangement relationship between the end bus bar EB12 of the cell stack CS1 and the end bus bar EB22 of the cell stack CS2 on the second end side.

As shown in FIG. 7, the tip end part of the end bus bar EB22 is arranged below the tip end part of the end bus bar EB12 and at a position shifted toward the second end side (the X-axis positive-side). Further, the tip end part of the end bus bar EB12 and the tip end part of the end bus bar EB22 are arranged side by side in the stacking direction of the rectangular cells C1 to C6. Therefore, the end bus bars EB12 and EB22 that are arranged so as to oppose each other do not interfere with each other on the second end side as in the case of the first end side, and an increase in spacing between the cell stacks CS1 and CS2 that are arranged side by side can be suppressed.

Here, as described above, the end plate EP1 of the cell stack CS1 is shifted closer to the X-axis positive-side than the end plate EP1 of the cell stack CS2. Therefore, the amount of shift of the tip end parts of the end bus bars EB12 and EB22 shown in FIG. 7 in the X-axis direction is smaller than the amount of shift of the tip end parts of the end bus bars EB11 and EB21 shown in FIG. 5 in the X-axis direction.

The connection destinations of the tip end parts of the end bus bars EB11 and EB21 shown in FIGS. 5 and 6 and the tip end parts of the end bus bars EB12 and EB22 shown in FIG. 7 are not illustrated, but they are not particularly limited.

For example, the tip end part of the end bus bars EB11 and EB21 shown in FIGS. 5 and 6 may be connected to each other by another bus bar (not shown) or the like, and the cell stacks CS1 and CS2 may be connected in series. In this case, the tip end part parts of the end bus bars EB12 and EB22 shown in FIG. 7 are not connected to each other, but are connected to, for example, a power supply destination or another cell stack (not shown).

On the other hand, the tip end part of the end bus bars EB12 and EB22 shown in FIG. 7 may be connected to each other by another bus bar (not shown) or the like, and the cell stacks CS1 and CS2 may be connected in series. In this case, the tip end part of the end bus bars EB11 and EB21 shown in FIGS. 5 and 6 are not connected to each other, but are connected to, for example, a power supply destination or another cell stack (not shown).

As described above, in the battery according to the present embodiment, as shown in FIG. 5, the tip end part of the end bus bar EB21 is arranged below the tip end part of the end bus bar EB11 and at a position shifted toward the first end side (X-axis negative-side). As shown in FIG. 6, the tip end part of the end bus bar EB11 and the tip end part of the end bus bar EB21 are arranged side by side in the stacking direction of the rectangular cells C1 to C6. Therefore, the end bus bars EB11 and EB21 that are arranged so as to oppose each other do not interfere with each other, and an increase in spacing between the cell stacks CS1 and CS2 that are arranged side by side can be suppressed.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. A battery comprising first and second cell stacks each having a rectangular parallelepiped shape and in which a plurality of rectangular cells, each having a terminal provided on respective end surfaces thereof in a longitudinal direction, are stacked, wherein
the first and second cell stacks are arranged side by side so that first and second ends of the first cell stack correspond to first and second ends of the second cell stack, respectively, in a stacking direction of the plurality of the rectangular cells,
a base part of a first end bus bar is fixed to a terminal of a rectangular cell of the first cell stack, which is positioned the closest to the first end of the first cell stack,
a base part of a second end bus bar is fixed to a terminal of a rectangular cell of the second cell stack, which is positioned the closest to the first end of the second cell stack,
a tip end part of the second end bus bar is arranged below a tip end part of the first end bus bar and at a position shifted toward the first end of the second cell stack, and
the tip end part of the first end bus bar and the tip end part of the second end bus bar are arranged side by side in the stacking direction of the plurality of the rectangular cells.

2. The battery according to claim 1, wherein
the tip end part of the first end bus bar is mounted on a first support stand that is fixed to the first end of the first cell stack, and
the tip end part of the second end bus bar is mounted on a second support stand that is fixed to the first end of the second cell stack.

3. The battery according to claim 2, wherein
a screw rod provided on the first support stand is inserted into a through hole provided in the tip end part of the first end bus bar, and
a screw rod provided on the second support stand is inserted into a through hole provided in the tip end part of the second end bus bar.

4. The battery according to claim 2, wherein
the first support stand is fixed to an end plate at the first end of the first cell stack, and
the second support stand is fixed to an end plate at the first end of the second cell stack.

5. The battery according to claim 4, wherein
the first support stand is bolted to the end plate at the first end of the first cell stack,
the second support stand is bolted to the end plate at the first end of the second cell stack, and
the end plate at the first end of the first cell stack and the end plate at the first end of the second cell stack are arranged at positions shifted in the stacking direction.
